(19) United States
(12) Patent Application Publication
(10) Pub. No.: US 2001/0014175 A1
(43) Pub. Date: Aug. 16, 2001

(54) Method for rapid color keying of color video images using individual color component look-up-tables

(75) Inventor: Amon Tavor, Moshav Mazor (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(73) Assignee: CHANNEL STORM LTD.

(21) Appl. No.: 09/820,616

(22) Filed: Mar. 30, 2001

Related U.S. Application Data
(63) Continuation-in-part of application No. 09/453,093, filed on Dec. 2, 1999.

(51) Int. Cl. G06K 9/00; G06K 9/36

(52) U.S. Cl. 382/167; 382/284

(57) ABSTRACT

A method for rapid color keying of color video images using individual color component Look-Up-Tables (LUTs), assigned, storing, and used for retrieving, unique sets of predetermined values, for calculating pixel transparency values of input image pixels of a color video input image, for rapidly generating output image pixels of a color video output image including selectively keyed out or transparent pixels. Pre-determined values of the individual color component LUTs are positive integer values, positive non-integer values, and zero. Particular sets of pre-determined values account for high tolerance to changes in lighting, high tolerance of color brightness, and/or, for mixing colors such as for generating smooth edges, of input image pixels of the color video input image. Optionally, processing of mathematical operations performed on the sets of the pre-determined values of the individual color component LUTs are rapidly performed by a hardware acceleration device for further decreasing computational load placed upon a data processor performing color keying of the color video input image, thereby providing a relatively simple, rapid, and cost effective method for color keying of color video images.

This is a Continuation-in-Part of U.S. patent application Ser. No. 09/453,093, filed Dec. 02, 1999, entitled “SYSTEM AND METHOD FOR RAPID COMPUTER IMAGE PROCESSING WITH LOOK-UP TABLES”.

### FIELD AND BACKGROUND OF THE INVENTION

The present invention relates to processing color video images and, more particularly, to a method for rapid color keying of color video images using individual color component Look-Up-Tables. The method features using individual color component Look-Up-Tables assigned, storing, and for retrieving, unique sets of pre-determined values associated with respective individual color components of at least one color selected to be keyed out or to be made transparent from a color video input image, for calculating pixel transparency values of input image pixels of the color video input image, for rapidly generating output image pixels of a color video output image including selectively keyed out or transparent pixels.

When processing color graphic, or video, images by a computerized image processing system, often the background of the video image needs to be ‘keyed out’, known in the art of image processing as being made transparent, so that the video image can be superimposed over a different background. For example, FIG. 1 is a schematic diagram illustrating the basic features of the process for color keying an exemplary color video input image 10. When viewing the weather forecast on television, a weatherman 12 often appears to be standing in front of an animated weather map 14. In the television studio, weatherman 12 stands in front of a plain blue screen 16, typically, a large, flat curtain made of blue fabric. When each image coming from the television camera is processed, all the blue pixels in color video input image 10, that is, the areas of each color video input image showing blue screen 16, are ‘keyed out’ and replaced by at least part of an ‘insert’ image 18 of animated weather map 14. This process is usually referred to as ‘color keying’, ‘chromatic keying’, or ‘chroma keying’, because the keying out is based on the color or chromatic values of the input image pixels. The resulting output image displayed by the television is a composite image 20 of weatherman 12 superimposed over animated weather map background 14.

Referring again to FIG. 1, current image processing techniques used for color keying out selected input image pixels, for example, input image pixels corresponding to blue screen background 16, of color video input image 10, compare the color of each input image pixel to the desired background color of an insert image such as insert image 18 of animated weather map 14, in order to determine which input image pixels should be keyed out or be made transparent. Since colors captured by a video camera are not completely accurate, a small range of change, or tolerance, in the desired background color must be taken into account. Furthermore, for seams or interfaces between the resulting keyed out color video input image 22, or, equivalently the resulting color video output image 22, following the keying out procedure, and insert image 18 of animated weather map 14 to appear smooth, for example, pixels associated with the edges, peripheral region, or outline, of the figure of weatherman 12, input image pixels containing a significant, but not entire, amount of the desired background color, should be made semi-transparent, meaning the color of those edge or interface input image pixels are mixed with the color of the desired background pixels, rather than being replaced by the color of the desired background pixels.

Such image processing techniques used for keying out color video images typically require substantial amounts of complex calculations and decisions to be made for each input image pixel of the color video input image, and therefore involve long and costly computer processing times. Using Look-Up-Tables, hereinafter, also referred to as LUTs, is generally known in various fields of technology for either replacing, or, at least simplifying and speeding up complex calculation and decision procedures performed by computerized digital processing. The present invention is focused on particularly using LUTs for significantly simplifying and speeding up color keying of color video images.

A Look-Up-Table (LUT) is a table of values stored by order in a one-dimensional array. Each LUT value is assigned, stored, and retrieved, by using a unique one-dimensional position index. A simple example of a LUT is LUT: 25, 100, 75, 0, 50. In this example, the LUT contains five values, in the range of 0 to 100. It is most common that position indices of a LUT start at 0, therefore, in this example, position indices are between 0 and 4, where value 25 is assigned, stored, and retrieved by using position index 0, the value of 100 is assigned, stored, and retrieved by using position index 1, and so on.

Prior art includes various teachings of using Look-Up-Tables for processing color graphic or video images. In U.S. Pat. No. 5,917,961, issued to Huonder, there is disclosed a method of using pre-calculated LUTs for convoluting pixel values of a source image for generating pixel values of an output image, with applications to image processing involving low pass filtering (blurring), high pass filtering (sharpening), edge detection, and edge enhancement. The disclosed method includes performing a transformation, for example, involving scaling, rotating, and/or translating of the source image. There is mention of a color LUT for providing an image color value or gray scale value corresponding to each pixel value. However, there is no description or suggestion for using separately defined color LUTs with respect to individual color components, for example, red, green, blue, or, Cr and Cb, or, U and V, of the chromatic part of the source image. Moreover, Huonder provides no description or suggestion relating to determining and/or using pixel transparencies, alpha components, or to keying out pixels, during the image processing.

In U.S. Pat. No. 6,122,012, issued to Segman, there is disclosed a method of selective color control of digital video images. The disclosed invention features a method of using simple color LUTs, whose values are calculated from uniquely defined color control functions, to digitally increase or decrease the saturation of a single color of the chromatic part of a video image, for example, CrCb, UV, or IQ, without affecting intensities or saturations of the remaining colors of the chromatic part of the same image. According to the disclosed method, a digital video input image is scanned, row by row, pixel by pixel. Each input image pixel value, defined from the chromatic part of the video input image, is assigned an address to be operated on by values in individual color LUTs. For each desired change in an individual color of that image, a new digital video output image is produced featuring the desired change in the individual color without affecting the remaining colors of that same image. Here too, there is no description or suggestion relating to determining and/or using pixel transparencies, alpha components, or to keying out pixels, during the method of selective color control.

In U.S. patent application Ser. No. 09/453,093, filed Dec. 02, 1999, by the same inventor of the present invention, the teachings of which are incorporated by reference as if fully set forth herein, there is disclosed a method for performing rapid computer image processing using color LUTs. In the disclosed method, a matrix of a plurality of individual color component, for example, red, green, blue, LUTs is first prepared by performing one or more of various image processing functions, such as inversion, changing brightness, changing contrast, changing hue, changing gamma, and clipping, on the values stored in each color component LUT, such that each value for the processed image is retrieved by using the original or input pixel value for accessing a corresponding value in the matrix of the color component LUTs. Accessed values of the separate color component LUTs are added to form final or output image pixels. For implementing the disclosed method, optionally, the actual processing of the values in the LUTs for each pixel can be rapidly performed by a hardware acceleration device, which also decreases the computational load placed upon the data processor performing the image processing.

In U.S. patent application Ser. No. 09/453,093, one of the preferred embodiments of the invention is where the three color, for example, red, green, blue, component system is extended by including a fourth component, known in the art of image processing as the alpha component or alpha channel, which is used for determining transparency or opacity of a pixel. The disclosed method for processing color image data using the matrix of three separate color component LUTs is thereby extended to processing color image data including the alpha component, whereby the matrix then includes the fourth, alpha, component in each separate color component LUT. Accordingly, the disclosed method can be used for manipulating the alpha component, for example, in order to invert or change the gamma of the alpha component. In particular, alpha components associated with separate color components may influence each other during the image processing. One briefly mentioned example is where colors of an image can be changed depending upon the transparency of a selected portion of an image, in order to fill transparent areas of that portion with a desired color. Another briefly mentioned example of implementing the disclosed method is for determining pixel transparency according to the color component values of the pixels, in order to key out, or make transparent, a selected portion of an image having pre-determined color levels.

Although exemplary applications are briefly mentioned, the disclosure of U.S. patent application Ser. No. 09/453,093 includes no details or enabling description for using separate color component LUTs for determining and/or using pixel transparencies, or to keying out pixels, of graphic or video images. Furthermore, the image processing method of that disclosure is particularly limited with respect to color keying of digital color video images for the following three main reasons.

First, the method of '093 is based on adding accessed values of the separate color component LUTs to form output image pixels. This aspect is not ideally suitable for color keying images, because just having one color component, for example, red or green or blue, rather than all color components, associated with a corresponding color component LUT storing non-zero values, affects the results of determining which pixels of the image are to be keyed out. Specifically, for processing pixels of an input image by associating, retrieving, and adding, values from the color component LUTs, by adding the LUT values one obtains non-zero values even when the value of only one of the color components falls within the range of values of the desired color to be keyed out or made transparent. For most effectively keying out a specific color of an input image, it is necessary to have a method for selectively identifying, and processing, pixels where each of all the color components, rather than just one color component, has a value within the range of values of the desired color to be keyed out or made transparent. Details of a method for performing such selective identification and pixel processing are provided in the disclosure of the present invention.

Second, the method of '093 includes no provision for controlling tolerance to changes in the key out color of an input image, for example, referring again to FIG. 1, when varying lighting conditions cause variations in the brightness of the television studio background.

Third, the method of '093 is based on preparing and using a matrix of a plurality of individual color component LUTs. While this technique is well applicable for performing sophisticated color image processing, for example, correcting colors by shifting color hues, due to the involvement of matrices of multiple component color LUTs, it requires excessive computation, and therefore, excessive computer resources, for color keying processes.

To one of ordinary skill in the art, there is thus a need for, and it would be useful to have a method for rapid color keying of color video images using individual color component Look-Up-Tables. Moreover, there is a need for such a method which is significantly simpler, more rapid, and therefore, more cost effective, than currently used techniques for color keying of color video images.

### SUMMARY OF THE INVENTION

The present invention relates to a method for rapid color keying of color video images using individual color component Look-Up-Tables. The method features using individual color component Look-Up-Tables assigned, storing, and for retrieving, unique sets of pre-determined values associated with respective individual color components of at least one color selected to be keyed out or to be made transparent from a color video input image, for calculating pixel transparency values of input image pixels of the color video input image, for rapidly generating output image pixels of a color video output image including selectively keyed out or transparent pixels. Pre-determined values assigned to, stored in, and retrieved from, the individual color component LUTs are selected from the group consisting of positive integer values, positive non-integer values, and zero.

For each input image pixel, the calculated transparency value is stored in a separate individual component, the alpha component, of that input image pixel, and the set of all the calculated transparency values of all the input image pixels of the color video input image is stored in the alpha channel of the color video input image. The functionality of the transparency value in the method of the present invention is that each input image pixel of the color video input image is to be keyed out or made transparent to a variable extent or degree according to the transparency value of that input image pixel, calculated according to the disclosed method.

In the method, optionally, processing of the mathematical operations, in particular, multiplication operations, performed on the sets of predetermined values assigned to, stored in, and retrieved from, the individual color component LUTs for each input image pixel of the color video input image are rapidly performed by a hardware acceleration device, which further decreases the computational load placed upon a data processor performing the color keying of the color video input image. Accordingly, the present invention provides a relatively simple, rapid, and therefore, cost effective method for color keying of color video images.

In a first particular embodiment of the method, each of the individual color component LUTs features a basic set of pre-determined values used for calculating pixel transparency values of input image pixels of the color video input image. In a second particular embodiment of the method, the luminance individual color component LUT features a set of predetermined values accounting for high tolerance to changes in lighting, affecting the luminance component or the overall level of the color, of input image pixels of the color video input image, used for calculating pixel transparency values of input image pixels of the color video input image. In a third particular embodiment of the method, at least one of the chromatic individual color component LUTs features a set of pre-determined values accounting for high tolerance of the respective at least one chromatic component of the color, of input image pixels of the color video input image, used for calculating pixel transparency values of input image pixels of the color video input image. In a fourth particular embodiment of the method, each of the individual color component LUTs features a set of pre-determined values accounting for mixing colors such as for generating smooth edges, from input image pixels of the color video input image, used for calculating pixel transparency values of input image pixels of the color video input image.

Thus, according to the present invention, there is provided a method for rapid color keying of a color video input image using individual color component Look-Up-Tables (LUTs), comprising the steps of: (a) receiving the color video input image, featuring input image pixels, by an image processing device; (b) characterizing the color video input image; (c) selecting a color to be keyed out from the color video input image and assigning a value to each individual color component of the selected color; (d) defining an individual color component LUT for each individual color component of the selected color to be keyed out from the color video input image, and assigning a set of pre-determined values to each defined individual color component LUT; (e) calculating a transparency value for each input image pixel of the color video input image from the individual color component LUTs of the selected color to be keyed out from the color video input image, for forming a plurality of the calculated transparency values of the input image pixels of the color video input image, whereby each input image pixel is to be keyed out or made transparent to a variable extent or degree from the color video input image according to the calculated transparency value of the input image pixel; (f) setting pixel transparency for each input image pixel of the color video input image, from the transparency value calculated for the input image pixel of the color video input image, for forming a plurality of the set pixel transparencies of the input image pixels of the color video input image; and (g) using the plurality of the set pixel transparencies of the color video input image for performing at least one procedure on the color video input image selected from the group consisting of an additional video image processing procedure on the color video input image and generating a color video output image corresponding to a keyed out form of the color video input image, each at least one procedure includes the keying out or making transparent the input image pixels associated with the selected color to be keyed out from the color video input image.

According to further features in preferred embodiments of the method described below, step (e) includes for each input image pixel of the color video input image: (i) retrieving a pre-determined value from each individual color component LUT, each pre-determined value is associated with a value of a respective individual color component of the input image pixel; and (ii) multiplying the predetermined values retrieved from the individual color component LUTs for forming the transparency value for the input image pixel.

According to further features in preferred embodiments of the method described below, the calculated transparency value of each input image pixel is selected from group consisting of integers 1 and 0, and, non-integers between 0 and 1, whereby each input image pixel of the color video input image having the calculated transparency value of the integer 1 is to be completely keyed out or to be made completely transparent from the color video input image, each input image pixel of the color video input image having the calculated transparency value of the integer 0 is not to be keyed out or not to be made transparent from the color video input image, and each input image pixel of the color video input image having the calculated transparency value of the non-integer between 0 and 1 is to be partially keyed out or partially made transparent from the color video input image.

According to further features in preferred embodiments of the method described below, in step (f) each calculated transparency value of each input image pixel is stored in a fourth individual component of the input image pixel, the fourth individual component is equivalent to an alpha component of the input image pixel, whereby set of all the calculated transparency values of all the input image pixels of the color video input image is stored in an alpha channel of the color video input image.

According to further features in preferred embodiments of the method described below, the alpha channel is stored in terms selected from the group consisting of integer values only, non-integer values only, and, a combination of integer values and non-integer values.

According to further features in preferred embodiments of the method described below, each calculated transparency value which is non-integer between 0 and 1 is multiplied by 255 and converted to an integer value prior to the storing in the alpha channel of the color video input image.

According to further features in preferred embodiments of the method described below, in step (d) the pre-determined values are positive integer and zero values only and there is including a maximal positive integer value in each set of the predetermined values of each individual color component LUT, whereby when the predetermined values are retrieved and multiplied for the forming the transparency value for each input image pixel of the color video input image, maximal calculated transparency value is 255 for each input image pixel, whereby the alpha channel of the transparency values is obtained and stored in terms of the positive integer values in a dynamic range of 0 to 255.

According to further features in preferred embodiments of the method described below, in step (d) in each set of the pre-determined values of each individual color component LUT there is a plurality of at least three predetermined values centered around and associated with each value of each respective individual color component of the selected color to be keyed out or made transparent from the color video input image, whereby there is the keying out or making transparent the input image pixels having a color within a range of the selected color to be keyed out or to be made transparent from the color video input image.

According to further features in preferred embodiments of the method described below, in step (d) in the set of the pre-determined values of a luminance individual color component LUT there is a plurality of at least five pre-determined values centered around and associated with a value of a respective luminance individual color component of the selected color to be keyed out or made transparent from the color video input image, whereby there is the keying out or making transparent the input image pixels having a luminance individual color component affected by varying lighting conditions within a high tolerance range of the luminance individual color component of the selected color to be keyed out or to be made transparent from the color video input image.

According to further features in preferred embodiments of the method described below, in step (d) in the set of the pre-determined values of at least one chromatic the individual color component LUT there is a plurality of at least five pre-determined values centered around and associated with a value of a respective at least one chromatic individual color component of the selected color to be keyed out or made transparent from the color video input image, whereby there is the keying out or making transparent the input image pixels having at least one chromatic individual color component within a high tolerance range of respective the at least one chromatic individual color component of the selected color to be keyed out or to be made transparent from the color video input image.

According to further features in preferred embodiments of the method described below, in step (d) the pre-determined values assigned to and stored in each individual color component LUT are selected from the group consisting of positive integer values, positive non-integer values, and zero, associated with the values of the respective individual color components of the selected color to be keyed out or made transparent from the color video input image, whereby each set of the pre-determined values in each individual color component LUT is used for mixing colors of the color video input image with colors of another color video image and for generating smooth edges from the input image pixels of the color video input image.

The present invention successfully addresses shortcomings and limitations of presently known methods for color keying of color video images, by being simpler, more rapid, and therefore, more cost effective, than currently used techniques for color keying of color video images. The method of the present invention is readily implemented using standard graphics acceleration hardware, also known as graphics processing units (GPU), for achieving super fast results and freeing a computer's CPU for performing other tasks. Moreover, the method of the present invention is generally applicable as a ‘stand-alone’ image processing tool, or, as an image processing tool used in combination with other methods, devices, and systems, performing color video image processing.

Implementation of the method of the present invention involves performing or completing selected tasks or steps manually, automatically, or a combination thereof. Moreover, according to actual instrumentation and equipment used for implementing a particular preferred embodiment of the disclosed method, several selected steps of the present invention could be performed by hardware and/or by software on any operating system of any firmware or a combination thereof. For example, as hardware, selected steps of the invention could be performed by a computer chip, an electronic circuit, and/or by a hardware acceleration device. As software, selected steps of the invention could be performed by a plurality of software instructions being executed by a computer using any suitable operating system. In any case, selected steps of the method of the present invention could be described as being performed by a data processor, such as a computing platform for executing a plurality of instructions.

### BRIEF DESCRIPTION OF THE DRAWINGS

The invention is herein described, by way of example only, with reference to the accompanying drawings, wherein:

FIG. 1 is a schematic diagram illustrating the basic features of the process for color keying an exemplary color video input image;

FIG. 2 is a schematic diagram illustrating the step of assigning a value to each individual color component of a selected color of the color video input image to be keyed out, and the step of assigning a basic set of pre-determined values to each individual color component LUT, used for calculating a transparency value of each input image pixel, in accordance with the present invention;

FIG. 3 is a schematic diagram illustrating the step of assigning a set of pre-determined values to each individual color component LUT, where the luminance (Y) individual color component LUT, Y-LUT, features a set of pre-determined values accounting for high tolerance to changes in lighting, affecting the luminance (Y) component or the overall level of the color, of input image pixels of the color video input image, used for calculating a transparency value for each input image pixel, in accordance with the present invention;

FIG. 4 is a schematic diagram illustrating the step of assigning a set of pre-determined values to each individual color component LUT, where each set of pre-determined values accounts for mixing colors such as for generating smooth edges, from input image pixels of the color video input image, used for calculating a transparency value for each input image pixel, in accordance with the present invention; and

FIG. 5 is a schematic diagram illustrating the step of assigning a set of pre-determined values to each individual color component LUT, where, alternatively, the pre-determined values of each set are positive integer and zero values only, including a ‘maximal’ positive integer value, used for calculating a transparency value for each input image pixel, in accordance with the present invention.

### DESCRIPTION OF THE PREFERRED EMBODIMENTS

The present invention relates to a method for rapid color keying of color video images using individual color component Look-Up-Tables. The method features using individual color component Look-Up-Tables assigned, storing, and for retrieving, unique sets of pre-determined values associated with respective individual color components of at least one color selected to be keyed out or to be made transparent from a color video input image, for calculating pixel transparency values of input image pixels of the color video input image, for rapidly generating output image pixels of a color video output image including selectively keyed out or transparent pixels. Pre-determined values assigned to, stored in, and retrieved from, the individual color component LUTs are selected from the group consisting of positive integer values, positive non-integer values, and zero.

For each input image pixel, the calculated transparency value is stored in a separate individual component, the alpha component, of that input image pixel, and the set of all the calculated transparency values of all the input image pixels of the color video input image is stored in the alpha channel of the color video input image. The functionality of the transparency value in the method of the present invention is that each input image pixel of the color video input image is to be keyed out or made transparent to a variable extent or degree according to the transparency value of that input image pixel, calculated according to the disclosed method.

In the method, optionally, processing of mathematical operations performed on the sets of pre-determined values assigned to, stored in, and retrieved from, the individual color component LUTs for each input image pixel of the color video input image are rapidly performed by a hardware acceleration device, which further decreases the computational load placed upon a data processor performing the color keying of the color video input image. Accordingly, the present invention provides a relatively simple, rapid, and therefore, cost effective method for color keying of color video images.

In a first particular embodiment of the method, each of the individual color component LUTs features a basic set of predetermined values used for calculating pixel transparency values of input image pixels of the color video input image. In a second particular embodiment of the method, the luminance individual color component LUT features a set of pre-determined values accounting for high tolerance to changes in lighting, affecting the luminance component or the overall level of the color, of input image pixels of the color video input image, used for calculating pixel transparency values of input image pixels of the color video input image. In a third particular embodiment of the method, at least one of the chromatic individual color component LUTs features a set of pre-determined values accounting for high tolerance of the respective at least one chromatic component of the color, of input image pixels of the color video input image, used for calculating pixel transparency values of input image pixels of the color video input image. In a fourth particular embodiment of the method, each of the individual color component LUTs features a set of pre-determined values accounting for mixing colors such as for generating smooth edges, from input image pixels of the color video input image, used for calculating pixel transparency values of input image pixels of the color video input image.

It is to be understood that the invention is not limited in its application to the details of the order or sequence of steps of operation or implementation, set forth in the following description, drawings, or examples. For example, the following description uses exemplary video color model YUV and individual color component LUTs, Y-LUT, U-LUT, and V-LUT, respectively, assigned, storing, and used for retrieving, only twenty exemplary values, in order to illustrate implementation of the present invention. Additionally, for better understanding the overall general method of the present invention, the description provided herein details a serial mode of implementation for serially selecting and processing more than one color to be keyed out or to be made transparent from the color video input image, however, it is to be clearly understood that the overall general method of the present invention is extendable and applicable to a parallel mode of implementation for simultaneously selecting and processing more than one color to be keyed out or to be made transparent from the color video input image. Accordingly, the invention is capable of other embodiments or of being practiced or carried out in various ways. Also, it is to be understood that the phraseology and terminology employed herein are for the purpose of description and should not be regarded as limiting.

Steps, components, operation, and implementation of a method for rapid color keying of color video images using individual color component Look-Up-Tables according to the present invention are better understood with reference to the following description and accompanying drawings. The general method for rapid color keying of color video images using individual color component Look-Up-Tables according to the present invention is herein described. Four particular embodiments of the general method of the present invention are described thereafter. Throughout the following description, when referring to ‘the method’ of the present invention it is to be clearly understood that reference, applicability, and implementation, are with respect to the general method, as well as to the particular embodiments of the general method, of the present invention. Throughout the following description and accompanying drawings, like reference numbers refer to like elements.

In Step (a) of the general method of the present invention, there is receiving a color video input image, featuring input image pixels, by an image processing device.

In Step (b), there is characterizing the color video input image.

Computer memory is ordinarily divided into bytes (units of 8 bits), each capable of holding 256 values. The color of each pixel in graphic or digital images, such as digital images of computer systems and video systems, is usually characterized by and comprised of several individual color components, most commonly three individual color components, and each individual color component is usually stored in the form of a single byte (8 bits) of computer memory. The most common color model used in computer systems is RGB (red, green, blue), which involves three byte size components to indicate the level, from 0 (darkest or black level) to 255 (brightest or white level), of each individual color component, R, G, and B. The common color model used in video systems is YUV, also known as YCrCb with Cr and Cb corresponding to U and V, respectively. In the YUV color model, individual color component Y is the luminance component indicating the overall level of the color, and individual color components U and V are the chromatic components indicating the chromatic levels of the color. According to a linear combination of the chromatic components of the color video input image, any number of different colors can be included in the method of the present invention. Examples of colors which can be used in the method of the present invention are selected from the group consisting of linear combinations of primary colors such as red, green, blue, yellow, magenta, and cyan, and non-primary colors such as pink, orange, violet.

The dynamic range of the values of each individual color component, Y, U, and V, is 0 to 255, with 0 and 255 corresponding to the black level and the white level, respectively. The value of individual color component Y can be calculated as the median of the values of the individual color components R, G, and B. The value of individual color component U (complement of R) can be calculated as the difference between the values of individual color components Y and R, while the value of individual color component V (complement of B) can be calculated as the difference between the values of individual color components Y and B. Accordingly, values of individual color components U and V are signed, positive or negative, since individual color components R and B are either larger or smaller than individual color component Y. Since the YUV color model is commonly used in video systems, it is often used in computer systems, instead of the common RGB color model, for video data. Accordingly, the description of the method of the present invention refers preferably to the YUV color model, which gives better looking results from color image processing, although the method is applicable to the RGB color model or any other color model featuring individual color components.

The color video input image features input image pixels, where each input image pixel has a color defined by any of the above described color models. In particular, the color video input image features input image pixels, where each input image pixel has a color preferably defined by the YUV color model, such that each input image pixel has a color defined by the three individual color components, Y, U, and V. In the color video input image, there is at least one color associated with a fraction, portion, or region, of the color video input image, which in turn is associated with a number of input image pixels to be keyed out or to be made transparent from the color video input image.

It is herein noted that above described Steps (a)-(b) can be optionally performed in coordination with operation of a hardware acceleration device, whereby, there is transferring, in turn or sequentially, the value of each individual color component, for example, Y, U, and V, of all the input image pixels of the color video input image, in the form of a single component image, to the hardware acceleration device. Further description of this optional procedure is provided below following description of Step (g) of the general method of the present invention.

In Step (c), there is selecting a color to be keyed out from the color video input image, and assigning a value to each individual color component of the selected color.

In the color video input image, there is at least one color associated with a fraction, portion, or region, of the color video input image, which in turn is associated with a number of input image pixels to be keyed out or made transparent from the color video input image. In principle, Step (c), and below described Step (d) through Step (g), can be implemented according to an implementation mode selected from the group consisting of a serial mode for serially selecting and processing more than one color to be keyed out or to be made transparent from the color video input image, and a parallel mode for simultaneously selecting and processing more than one color to be keyed out or to be made transparent from the color video input image. For better understanding the overall general method of the present invention, the description provided herein details the serial mode for serially selecting and processing more than one color to be keyed out or to be made transparent from the color video input image, however, it is to be clearly understood that the overall general method of the present invention is extendable and applicable to the parallel mode for simultaneously selecting and processing more than one color to be keyed out or to be made transparent from the color video input image.

Preferably, there is selecting a color defined by the three individual color components, that is, the luminance component, Y, and, the chromatic components, U and V. For example, in FIG. 1, the color blue of the blue screen background 16 is selected to be keyed out or made transparent from color video input image 10, which is to be used for keying out or making transparent a number of input image pixels associated with the selected color blue.

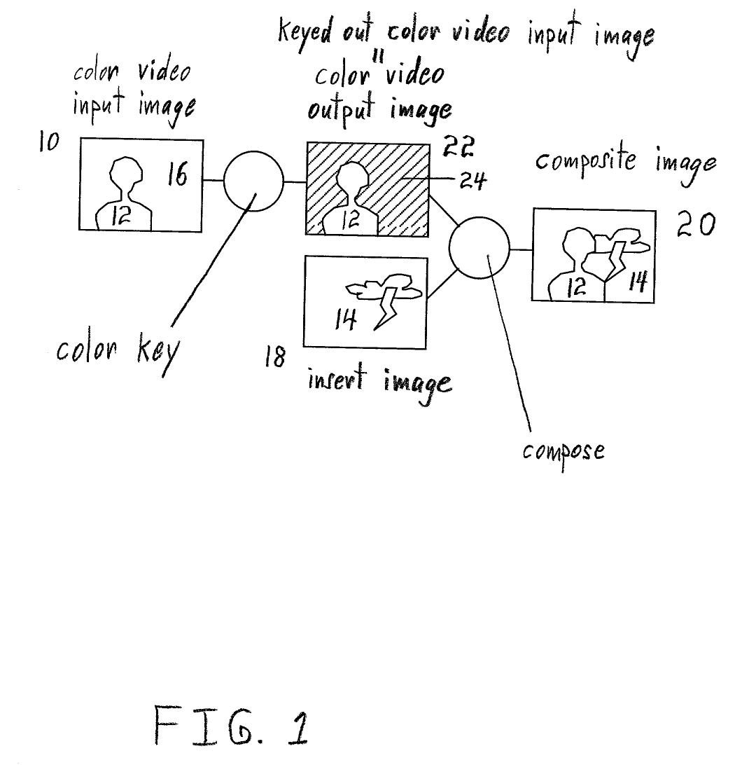

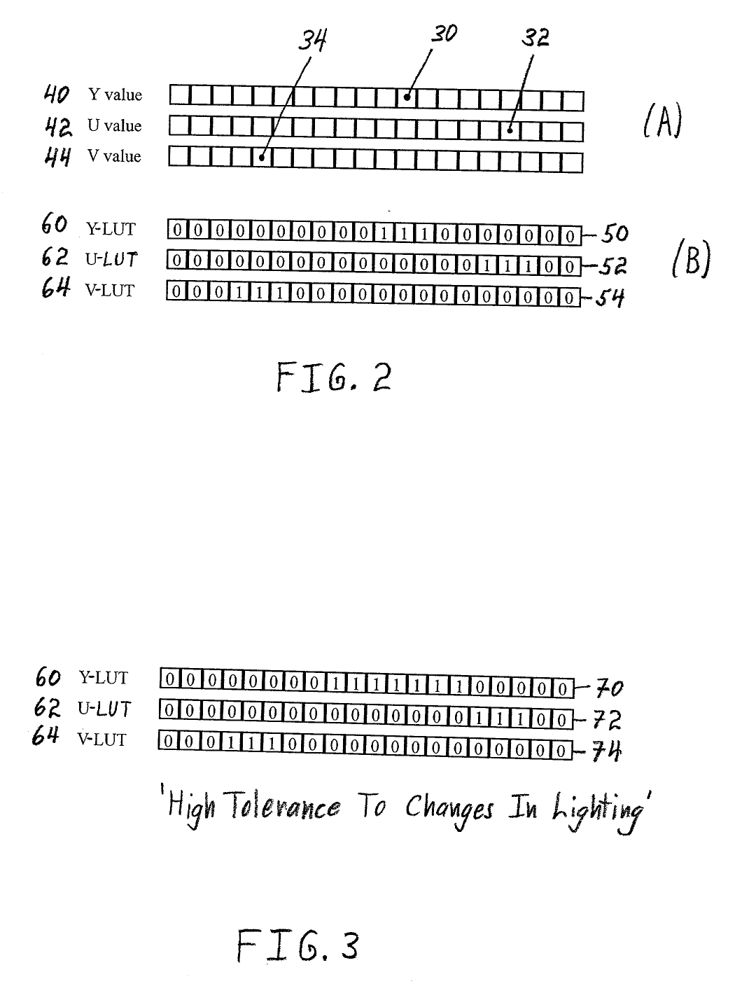

A value is assigned to each individual color component, Y, U, and V, of the selected color to be keyed out. In general, the dynamic range of the value assigned to each individual color component, Y, U, and V, is 0 to 255, with 0 and 255 corresponding to the black level and the white level, respectively. Accordingly, in general, each individual color component, Y, U, and V, is assigned a value from the 256 possible values in the dynamic range. For example, in FIG. 2, (A) illustrates the step of assigning a value, for example, value 30, value 32, and value 34, to each individual color component, Y 40, U 42, and V 44, respectively, of a selected color to be keyed out from the color video input image. For simplicity, FIG. 2 shows each individual color component, Y 40, U 42, and V 44, containing a set of only twenty possible values, instead of the generally used set of 256 possible values.

In Step (d), there is defining an individual color component LUT for each individual color component of the selected color to be keyed out from the color video input image, and assigning a set of pre-determined values to each defined individual color component LUT.

In particular, there is defining an individual color component LUT for each individual color component, Y, U, and V, of the selected color to be keyed out or made transparent from the color video input image. Accordingly, there is defining a Y individual color component LUT, a U or first chromatic individual color component LUT, and a V or second chromatic individual color component LUT, hereinafter, also referred to as Y-LUT, U-LUT, and V-LUT, respectively. Each individual color component LUT, Y-LUT, U-LUT, and V-LUT, is defined as a table of a set of pre-determined values which are assigned to, stored in, and retrieved from, the individual color component LUT, by using a unique one-dimensional position index of a one-dimensional array.

A main aspect of novelty of the method of the present invention, is that, in general, each individual color component LUT, Y-LUT, U-LUT, and V-LUT, is assigned a set of pre-determined values which are to be used for determining, by calculation, a transparency value for each input image pixel of the color video input image. The functionality of the transparency value in the method of the present invention is that each input image pixel of the color video input image is to be keyed out or made transparent to a variable extent or degree according to the transparency value of that input image pixel, calculated according to sub-steps (i)-(ii) of Step (e) described below.

The reason for defining an individual color component LUT, Y-LUT, U-LUT, and V-LUT, for each individual color component, Y, U, and V, respectively, of the selected color to be keyed out or made transparent from the color video input image is as follows. In principle, in order to key out or make transparent those input image pixels having a color identical and/or similar to the selected color to be keyed out or made transparent from the color video input image, there is defining a single global LUT featuring a set of pre-determined values which are assigned to, stored in, and retrieved from, the global LUT, by using a unique one-dimensional position index of a one-dimensional array, whereby the pre-determined values are used for calculating a transparency value for each input image pixel of the color video input image.

For example, by using such a global LUT, an exemplary pre-determined value of 1 could be used for meaning that a given input image pixel is to be completely keyed out or to be made completely transparent, and an exemplary pre-determined value of 0 could be used for meaning that a given input image pixel is not to be keyed out or not to be made transparent, by any extent or degree, from the color video input image. Such a global LUT contains a pre-determined value for each possible color in the color video input image. Accordingly, each input image pixel having a color identical and/or similar to the selected color to be keyed out or made transparent from the color video input image is assigned the predetermined value of 1, and each of the remaining input image pixels is assigned the pre-determined value of 0.

However, for the color video input image characterized by one of the above described color models featuring three individual color components, where each individual color component is assigned a value from the generally used 256 possible values in the dynamic range, there are 16,777,216 (256 to the power of three) possible colors in the color video input image. Since it is not practical to define and use such a single global LUT storing this large number of pre-determined values in a correspondingly large one-dimensional array, there is defining an individual color component LUT for each individual color component of the selected color to be keyed out from the color video input image, and assigning a set of pre-determined values to each defined individual color component LUT, where each set features a significantly smaller number, for example, preferably, 256, of predetermined values than the impracticably large single set of predetermined values featured in a single global LUT.

Accordingly, in Step (d), there is assigning a set of pre-determined values to each defined individual color component LUT, according to unique one-dimensional indices, whose values are associated with the 256 possible values in the above described dynamic range of each individual color component, Y, U, and V, of the selected color to be keyed out or made transparent from the color video input image. In general, the pre-determined values of each set, assigned to, stored in, and retrieved from, the individual color component LUTs are selected from the group consisting of positive integer values, positive non-integer values, and zero.

For example, in FIG. 2, (B) illustrates the step of assigning a basic set, for example, set 50, set 52, and set 54, of pre-determined values to each individual color component LUT, Y-LUT 60, U-LUT 62, and V-LUT 64, respectively, whose values are associated with the values 30, 32, and 34, respectively, of each individual color component, Y 40, U 42, and V 44, respectively, of a selected color, such as blue of a background, to be keyed out or made transparent from a color video input image, such as color video input image 10 shown in FIG. 1. In this example, the pre-determined values in each set 50, 52, and 54, are integer values of 1 and 0, whereby, each of the plurality of pre-determined values in each set is 1 or 0.

FIG. 3 illustrates another example of the step of assigning a set, for example, set 70, set 72, and set 74, of pre-determined values to each individual color component LUT, Y-LUT 60, U-LUT 62, and V-LUT 64, respectively, whose values are associated with the values of each individual color component, Y 40, U 42, and V 44, (FIG. 2) respectively, of a selected color, such as blue of a background 16, to be keyed out or to be made transparent from a color video input image, such as color video input image 10 shown in FIG. 1. In this example, the pre-determined values in each set 70, 72, and 74, are also integer values of 1 and 0, but, here, the set of the pre-determined values in the Y-LUT 60 accounts for high tolerance to changes in lighting, affecting the luminance (Y) component or the overall level of the color, of input image pixels of the color video input image, described in more detail below following description of the general method of the present invention.

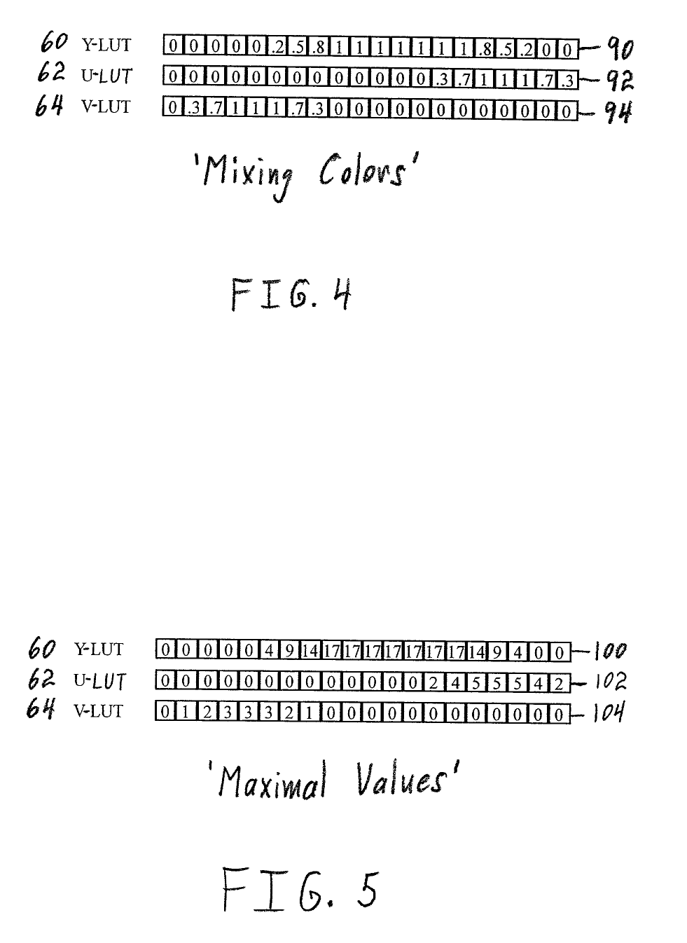

In another example, FIG. 4 illustrates the step of assigning a set, for example, set 90, set 92, and set 94, of pre-determined values to each individual color component LUT, Y-LUT 60, U-LUT 62, and V-LUT 64, respectively, whose values are associated with the values of each individual color component, Y 40, U 42, and V 44, (FIG. 2) respectively, of a selected color, such as blue of a background 16, to be keyed out or made transparent from a color video input image, such as color video input image 10 shown in FIG. 1. In this example, the predetermined values in sets 90, 92, and 94, are integer values of 1 and 0, and, positive non-integer values of 0.8, 0.7, 0.5, 0.3, and 0.2, where, here, in addition to the set 90 of the pre-determined values in the Y-LUT 60 accounting for high tolerance to changes in lighting, affecting the luminance (Y) component or the overall level of the color, of input image pixels of the color video input image, the set 90, 92, and 94, of the pre-determined values in each individual color component LUT, Y-LUT 60, U-LUT 62, and V-LUT 64, respectively, accounts for mixing colors such as for generating smooth edges from input image pixels of the color video input image, described in more detail below following description of the general method of the present invention.

Again, for simplicity, FIGS. 2-4 show each individual color component LUT, Y-LUT 60, U-LUT 62, and V-LUT 64, containing a set of only twenty possible pre-determined values, instead of the generally used set of 256 possible pre-determined values.

In Step (e), there is calculating a transparency value for each input image pixel of the color video input image, from the individual color component LUTs of the selected color to be keyed out from the color video input image.

As previously indicated, the functionality of the transparency value in the method of the present invention is that each input image pixel of the color video input image is to be keyed out or to be made transparent to a variable extent or degree according to the transparency value of that input image pixel calculated according to sub-steps (i)-(ii) of Step (e) described below. For example, and in a non-limiting way, each input image pixel of the color video input image having a calculated transparency value of 1 is to be completely keyed out or to be made completely transparent from the color video input image, and, each input image pixel of the color video input image having a calculated transparency value of 0 is not to be keyed out or not to be made transparent from the color video input image. Alternatively, and preferably, in addition to simply using a transparency value of 1 or 0 only, for either completely keying out or not keying out at all, respectively, an input image pixel from the color video input image, there is also using a positive non-integer calculated transparency value, that is, between 0 and 1, for partially keying out or partially making transparent an input image pixel from the color video input image.

In sub-step (i) of Step (e), for each input image pixel of the color video input image, there is retrieving a pre-determined value from each individual color component LUT, associated with a value of the respective individual color component of that input image pixel. More specifically, for each input image pixel of the color video input image, there is retrieving a pre-determined value from each individual color component LUT, Y-LUT, U-LUT, and V-LUT, associated with a value of the respective individual color component, Y, U, and V, of that input image pixel.

In sub-step (ii) of Step (e), for each input image pixel of the color video input image, there is performing a mathematical operation on the pre-determined values retrieved from the individual color component LUTs, for forming the transparency value for that input image pixel. More specifically, for each input image pixel of the color video input image, there is performing a mathematical operation on the pre-determined values retrieved from the individual color component LUTs, Y-LUT, U-LUT, and V-LUT, for forming the transparency value for that input image pixel. Preferably, the mathematical operation is multiplication, whereby, for each input image pixel of the color video input image, there is multiplying the pre-determined values retrieved from the individual color component LUTs, Y-LUT, U-LUT, and V-LUT, for forming the transparency value for that input image pixel.

For example, in FIGS. 2 and 3, wherein pre-determined values assigned to, stored in, and retrieved from, each individual color component LUT, Y-LUT 60, U-LUT 62, and V-LUT 64, are values of 1 or 0 only, for each input image pixel of the color video input image, there is multiplying three numbers, corresponding to one pre-determined value retrieved from each individual color component LUT, Y-LUT 40, U-LUT 42, and V-LUT 44, respectively, of varying combinations of the values 1 and 0, for forming the transparency value for that input image pixel. More specifically, for any given input image pixel, there are possible multiplication operations of: 1×1×1, forming the transparency value of 1, or, 0×0 ×0, or, 1×0×0, or, 0×1×0, or, 0×0×1, or, 1×1×0, or, 0×1×1, or, 1×0×1, each forming the transparency value of 0, for that input image pixel.

Similarly, in FIG. 4, wherein pre-determined values assigned to, stored in, and retrieved from, each individual color component LUT, Y-LUT 60, U-LUT 62, and V-LUT 64, are values of 1 and 0, and, positive non-integer values between 1 and 0 such as 0.8, 0.7, 0.5, 0.3, and 0.2, for each input image pixel of the color video input image, there is multiplying three numbers, corresponding to one predetermined value retrieved from each individual color component LUT, Y-LUT 40, U-LUT 42, and V-LUT 44, respectively, of varying combinations of these values, for forming the transparency value for that input image pixel. More specifically, for any given input image pixel, a few exemplary of all possible multiplication operations are those previously listed above for FIGS. 2 and 3, for forming the transparency value of 1 or 0, plus additional exemplary multiplication operations involving varying combinations including one or more of the above listed positive non-integers, such as: 1×0.7×0.3, or, 0.8×0.5×0, or, 0.2×1×1, or, 0×1×0.7, and so on for other combinations, for forming an appropriate positive non-integer or zero product corresponding to the transparency value of that input image pixel.

It is herein noted that above described Step (e) can be optionally performed in coordination with operation of a hardware acceleration device, whereby, there is using the hardware acceleration device for multiplying the pre-determined values retrieved from the individual color component LUTs, Y-LUT, U-LUT, and V-LUT, associated with respective individual or separate single component images formatted as indexed color images. Further description of optionally using a hardware acceleration device for calculating transparency values of the input image pixels is provided below following description of Step (g) of the general method of the present invention.

In Step (f), there is setting pixel transparency for each input image pixel of the color video input image, from the corresponding transparency value calculated for that input image pixel of the color video input image, for forming a plurality of set pixel transparencies of the color video input image.

Step (f) is preferably performed by storing the calculated transparency value, obtained from previously described Step (e), of each input image pixel in a fourth individual component, known in the art of image processing as the alpha component, of that input image pixel. The set of all the calculated transparency values of all the input image pixels of the color video input image is stored in a channel usually referred to in the art as the alpha channel.

As for the individual color components of each pixel, the alpha channel is commonly stored in terms of integer values, rather than in terms of non-integer values, in the above described dynamic range of 0 to 255. For accomplishing this task, each calculated transparency value which is a positive non-integer, that is, between 0 and 1, needs to be multiplied by 255 and converted to a positive integer value prior to being stored in the alpha channel of the color video input image. This procedure is straight forward and relatively simple, however, it ordinarily involves a relatively large amount of computational resources.

To eliminate these extra computational steps, for each color selected for keying out or making transparent from the color video input image, above described Step (d) through Step (f) are alternatively performed using positive integer and zero values only in the individual color component LUTs. Accordingly, in Step (d), alternatively, there is defining an individual color component LUT for each individual color component of the selected color to be keyed out from the color video input image, and assigning a set of pre-determined values to each defined individual color component LUT, where the pre-determined values are positive integer and zero values only. In particular, there is defining an individual color component LUT, Y-LUT, U-LUT, and V-LUT, for each individual color component, Y, U, and V, respectively, of the selected color to be keyed out or made transparent from the color video input image, and assigning a set of pre-determined values to each defined individual color component LUT, Y-LUT, U-LUT, and V-LUT, where the pre-determined values are positive integer and zero values only.

For implementing this alternative procedure of using positive integer and zero values in the individual color component LUTs, it is required that the alpha channel of transparency values be obtained and stored in terms of integer values in the above described dynamic range of 0 to 255. To accomplish this, there is including a ‘maximal’ positive integer value in each set of the pre-determined values assigned to, stored in, and retrieved from, each individual color component LUT, Y-LUT, U-LUT, and V-LUT, which, when retrieved and multiplied according to previously described sub-steps (i)-(ii) of Step (e) for forming a transparency value for each input image pixel of the color video input image, the maximal calculated transparency value is 255 for each input image pixel.

An example of this alternative procedure is shown in FIG. 5, a schematic diagram illustrating the step of assigning a set, for example, set 100, set 102, and set 104, of pre-determined values to each individual color component LUT, Y-LUT 60, U-LUT 62, and V-LUT 64, respectively, where, alternatively, the pre-determined values of each set 100, 102, and 104, are positive integer and zero values only, including a ‘maximal’ positive integer value, used for calculating a transparency value for each input image pixel of the color video input image. In FIG. 5, set 100 of pre-determined values assigned to, stored in, and retrieved from, individual color component Y-LUT 60 includes the maximal positive integer value of 17, while set 102 of pre-determined values assigned to, stored in, and retrieved from, individual color component U-LUT 62 includes the maximal positive integer value of 5, and, set 104 of pre-determined values assigned to, stored in, and retrieved from, individual color component V-LUT 64, includes the maximal positive integer value of 3. Accordingly, for performing previously described sub-steps (i)-(ii) of Step (e) for forming a transparency value for each input image pixel of the color video input image, when multiplying the maximal pre-determined value, that is, 17, 5, and 3, retrieved from each corresponding set 100, 102, and 104, of pre-determined values of each individual color component LUT, Y-LUT 40, U-LUT 42, and V-LUT 44, respectively, that is, 17×5×3, the maximal calculated transparency value is 255 for each input image pixel of the color video input image.

The alpha channel of the color video input image, and therefore, the alpha component of each input image pixel of the color video input image, are used in the following step, Step (g), wherein there is performing additional video image processing on the color video input image, and/or, there is generating an output image corresponding to the keyed out input image, including the keyed out or transparent input image pixels from the keyed out input image.

As indicated in previously described Step (b) and Step (c), in the color video input image, there is at least one color associated with a fraction, portion, or region, of the color video input image, which in turn is associated with a number of input image pixels to be keyed out or made transparent from the color video input image. Accordingly, for each additional color selected for keying out or making transparent from the same color video input image, Step (f) further includes repeating above described Step (c) through Step (f). According to the number of colors, for example, at least one color, selected for keying out or making transparent from the color video input image, then, following that number of sequences, for example, at least one sequence, of above described Step (c) through Step (f), there is continuing the method of the present invention with the next step, Step (g).

In Step (g), there is using the plurality of set pixel transparencies of the color video input image for performing at least one procedure on the color video input image, selected from the group consisting of an additional video image processing procedure on the color video input image and generating a color video output image corresponding to a keyed out form of the color video input image, where each of the at least one procedure includes keying out or making transparent the input image pixels associated with the selected color to be keyed out or made transparent from the color video input image.

In particular, in Step (g), there is either performing additional video image processing using the alpha channel of the color video input image, and therefore, the alpha component of each input image pixel of the color video input image, and/or, there is generating a color video output image corresponding to a keyed out form of the color video input image, including the keyed out or transparent input image pixels from the keyed out color video input image.

As previously described in Step (e), each input image pixel of the color video input image is to be keyed out or be made transparent to a variable extent or degree according to the calculated transparency value of that input image pixel. Preferably, but in a non-limiting way, using exemplary pre-determined values in sets 50, 52, and 54, and, in sets 70, 72, and 74, of individual color component LUTs, Y-LUT 60, U-LUT 62, and V-LUT 64, of FIGS. 2 and 3, respectively, each input image pixel of the color video input image having a calculated transparency value of 1 is to be completely keyed out or to be made completely transparent from the color video input image, and, each input image pixel of the color video input image having a calculated transparency value of 0 is not to be keyed out or not to be made transparent from the color video input image. Alternatively, and preferably, as in the example illustrated in FIG. 4, using exemplary pre-determined values in sets 90, 92, and 94, of individual color component LUTs, Y-LUT 60, U-LUT 62, and V-LUT 64, respectively, in addition to simply using a transparency value of 1 or 0 only, for either completely keying out or not keying out at all, respectively, the input image pixel from the color video input image, here, there is also using a positive non-integer calculated transparency value, that is, between 0 and 1, for partially keying out or partially making transparent the input image pixel from the color video input image.

An example of performing additional video image processing using the alpha channel of the color video input image, and therefore, the alpha component of each input image pixel of the color video input image, obtained from Step (f), is where there is combining, also referred to as compositing, the color video input image associated with an alpha channel and therefore alpha components of the color video input image, with another video image, for forming a composite color video image. This is illustrated in FIG. 1, where the alpha channel, and therefore the alpha component of each input image pixel, of color video input image 10 of weatherman 12 in front of blue screen background 16, where pixels associated with blue screen background 16 are to be keyed out or to be made transparent, are used for compositing, by acting as a factor for blending or mixing the input image pixel colors with the colors of the corresponding pixels in the desired background of an insert image such as insert image 18 of animated weather map 14, for forming composite image 20 of weatherman 12 in front of animated weather map 14.

Additionally, or alternatively, in Step (g), there is generating a color video output image corresponding to a keyed out color video input image, including the keyed out or transparent input image pixels from the keyed out color video input image. The color video output image is defined as corresponding to the color video input image following the keying out procedure, that is, following completion of Step (f). Accordingly, the color video output image features output image pixels, where each output image pixel has a color defined by any of the above described color models.

This is illustrated in FIG. 1, where following keying out or making transparent input image pixels from color video input image 10, there is generating a color video output image 22 corresponding to the keyed out color video input image, including the keyed out or transparent input image pixels from the keyed out color video input image. Color video output image 22 features output image pixels 24, where each output image pixel has a color defined by the YUV color model, such that each output image pixel has a color defined by the three individual color components, Y, U, and V. Corresponding to the color video input image following the keying out procedure, the color video output image includes a corresponding number of input image pixels which have been keyed out or made transparent which are associated to a variable extent or degree with the selected color to be keyed out from the color video input image. Moreover, the color video output image, for example, color video output image 22 shown in FIG. 1, can be used for performing additional video image processing.

Many computerized systems currently in use include special hardware for accelerating the performance or processing of graphical or digital operations, such as texture mapping and compositing. Such hardware usually does not perform relatively sophisticated color keying such as the above described method of the present invention. However, when using individual color component LUTs for keying out or making transparent input image pixels associated with a selected color to be keyed out from the color video input image, according to the method of the present invention, hardware acceleration can be utilized for processing the mathematical operations, in particular, the multiplication operations, performed, according to above described sub-step (ii) of Step (e), on the sets of pre-determined values assigned to, stored in, and retrieved from, the individual color component LUTs for each input image pixel of the color video input image, where the sets of the pre-determined values are calculated by using software programs.

This combined procedure can be accomplished by transferring, in turn or sequentially, the value of each individual color component, for example, Y, U, and V, of all the input image pixels of the color video input image, in the form of a single component image, to a hardware acceleration device, in accordance with above described Steps (a)-(b). Each single component image, one for each individual color component, is then associated with the respective individual color component LUT, Y-LUT, U-LUT, and V-LUT, whose values, calculated by using software programs, are associated with the values of each individual color component, Y, U, and V, respectively, of the selected color to be keyed out or made transparent from the color video input image, in accordance with above described Steps (c)-(d). The single component image format is commonly referred to in the art of image processing as an indexed color image.

Then, the hardware acceleration device is used for multiplying the pre-determined values retrieved from the individual color component LUTs associated with the respective individual or separate indexed color images, in accordance with above described Step (e), for generating the color video output image corresponding to the keyed out color video input image, including the keyed out or transparent input image pixels from the keyed out color video input image, in accordance with above described Step (g). Here, the color video output image is generated by drawing the individual or separate indexed color images on top of each other in a multiplication mode.

In this procedure, each individual color component LUT, Y-LUT, U-LUT, and V-LUT, may be assigned, stores, and used for retrieving, a set of pre-determined values in the above described dynamic range of 0 to 255 of each individual color component, Y, U, and V, of the selected color to be keyed out or made transparent from the color video input image, since the hardware acceleration device can be set for normalizing the products of the multiplication operations to remain within that dynamic range. This optional procedure in the method of the present invention further decreases computational load placed upon a data processor, since the multiplication operations performed on the pre-determined values of the individual color component LUTs for each input image pixel are done entirely by the hardware acceleration device, while freeing the CPU of the data processor for performing other software tasks, thereby providing a relatively simple, rapid, and therefore, cost effective method for color keying of color video images.

Above described Step (a) through Step (g), and optional use of a hardware acceleration device for accelerating the performance of selected parts of Step (a) through Step (g), correspond to the general method for rapid color keying of color video images using individual color component Look-Up-Tables according to the present invention, however, it is to be clearly understood that above described Steps (a) through (g), and optional use of a hardware acceleration device for accelerating implementation of the invention, are readily extendable and applicable to the following description of four particular embodiments of the general method.

In the first particular embodiment of the general method, each of the individual color component LUTs features a basic set of pre-determined values used for calculating a transparency value of each input image pixel of a color video input image. This first particular embodiment is understood by referring again to FIG. 2, which illustrates Step (d), the step of assigning a basic set, for example, set 50, set 52, and set 54, of pre-determined values to each individual color component LUT, Y-LUT 60, U-LUT 62, and V-LUT 64, respectively, whose values are associated with the values of each individual color component, Y 40, U 42, and V 44, respectively, of a selected color, for example, blue of background 16, to be keyed out or to be made transparent from a color video input image, for example, color video input image 10 shown in FIG. 1. In this particular embodiment, the pre-determined values of each set, set 50, set 52, and set 52, are integer values of 1 and 0, whereby, each of the plurality of pre-determined values in each set is 1 or 0.

In FIG. 2, it is particularly noted that in each of the individual color component LUTs, Y-LUT 60, U-LUT 62, and V-LUT 64, there are three, rather than only one, pre-determined values, in this case, three pre-determined values of 1, associated with the value of the respective individual color component, Y 40, U 42, and V 44, of the selected color to be keyed out or to be made transparent from the color video input image. More specifically, the three pre-determined values of 1 in each individual color component LUT, Y-LUT 50, U-LUT 52, and V-LUT 54, correspond to (i) the actual value, (ii) the immediately preceding value, and (iii), the immediately succeeding value, of the respective individual color component, Y 40, U 42, and V 44, of the selected color, for example, blue of background 16, to be keyed out or to be made transparent from a color video input image, for example, color video input image 10 shown in FIG. 1.

Accordingly, Step (d) in the first particular embodiment of the general method of the present invention is implemented whereby in the set of pre-determined values of each individual color component LUT, Y-LUT, U-LUT, and V-LUT, there is at least one pre-determined value, preferably three pre-determined values centered around and associated with the value of the respective individual color component, Y, U, and V, of the selected color to be keyed out or to be made transparent from the color video input image. Other steps and aspects of implementing the first particular embodiment of the method are the same and in accordance with the above described general method. The objective of using this first particular embodiment of the general method is for enabling the keying out or making transparent input image pixels having a color in a range of, either nearly identical or similar to, in addition to identical to, the selected color to be keyed out or to be made transparent from the color video input image.

In the second particular embodiment of the method, the individual color component LUTs feature sets of pre-determined values accounting for high tolerance to changes in lighting, affecting the luminance component or the overall level of the color, of input image pixels of the color video input image, used for calculating pixel transparency values of input image pixels of the color video input image. This second particular embodiment is understood by referring again to FIG. 3, which illustrates Step (d), the step of assigning a set, for example, set 70, set 72, and set 74, of pre-determined values to each individual color component LUT, Y-LUT 60, U-LUT 62, and V-LUT 64, respectively, whose values are associated with the values of each individual color component, Y 40, U 42, and V 44, ((A) of FIG. 2) respectively, of a selected color, for example, blue of background 16, to be keyed out or made transparent from a color video input image, for example, color video input image 10 shown in FIG. 1. In this second particular embodiment, the pre-determined values of each set 70, set 72, and set 74, are also integer values of 1 and 0, but, here, the luminance (Y) individual color component LUT, Y-LUT 60, features a set, set 70, of pre-determined values accounting for high tolerance to changes in lighting, affecting the luminance (Y) component or the overall level of the color, of input image pixels of the color video input image, further described as follows.

Varying lighting conditions may affect the appearance of the part or region of the color video input image corresponding to the selected color, for example, blue of background 16, to be keyed out or to be made transparent from the color video input image, for example, color video input image 10 shown in FIG. 1. If the part or region of the color video input image, and therefore, the input image pixels, having the selected color to be keyed out or to be made transparent are not evenly lit, or if a shadow falls on that part or region of the color video input image, then some portion or fraction of that part or region, and therefore, some portion or fraction of the input image pixels, having the selected color to be keyed out or to be made transparent from the color video input image, may have a lighter or darker color than expected, thereby losing the expected or ordinarily calculated transparency. There is thus a need to increase tolerance to light changes in the method of color keying the color video input image.

Since such changes in lighting affect only the luminance component or the overall level of the selected color to be keyed out or to be made transparent from the color video input image, there is increasing the tolerance to light, by allowing a larger difference in the luminance (Y) component, while maintaining a relatively small difference in the chromatic (U and V) components, of the selected color to be keyed out, in order to prevent other colors of the color video input image from being keyed out or becoming transparent. An example of this procedure is provided as follows with reference again to FIG. 3.

In FIG. 3, it is particularly noted that in the luminance (Y) individual color component LUT, Y-LUT 60, there is a plurality of seven, rather than a plurality of three as shown in FIG. 2, pre-determined values of 1 associated with the value of the luminance (Y) individual color component of the selected color to be keyed out or to be made transparent from the color video input image. More specifically, the seven pre-determined values of 1 in the luminance (Y) individual color component LUT, Y-LUT 60, correspond to (i) the actual value, (ii) the three immediately preceding values, and, (iii) the three immediately succeeding values, of the luminance (Y) individual color component of the selected color, for example, blue of background 16, to be keyed out or to be made transparent from a color video input image, for example, color video input image 10 shown in FIG. 1.

Accordingly, Step (d) in the second particular embodiment of the general method of the present invention is implemented whereby in the set of pre-determined values of the luminance (Y) individual color component LUT, Y-LUT, there is a plurality of pre-determined values, preferably at least five or seven pre-determined values centered around and associated with the value of the luminance (Y) individual color component, of the selected color to be keyed out or made transparent from the color video input image. Other steps and aspects of implementing the second particular embodiment of the method are the same and in accordance with the above described general method. The objective of using this second particular embodiment of the general method is for enabling the keying out or making transparent input image pixels having a color affected by varying lighting conditions within a high tolerance range of the selected color to be keyed out or to be made transparent from the color video input image, rather than being restricted or limited to keying out or making transparent input image pixels having a color either nearly identical or similar, in addition to identical, to the selected color to be keyed out or to be made transparent from the color video input image.

In the third particular embodiment of the method, at least one of the chromatic individual color component LUTs features a set of pre-determined values accounting for high tolerance of the respective at least one chromatic component of the color, while either maintaining or decreasing the tolerance of the luminance component or the overall level of the color, of input image pixels of the color video input image, used for calculating pixel transparency values of input image pixels of the color video input image. This process is often referred to as ‘luma-keying’. This third particular embodiment is not explicitly illustrated, however, it is clearly understood by referring again to FIG. 3, which illustrates Step (d) of the previously described second particular embodiment of the method, the step of assigning a set, for example, set 70, set 72, and set 74, of pre-determined values to each individual color component LUT, Y-LUT 60, U-LUT 62, and V-LUT 64, respectively, whose values are associated with the values of each individual color component, Y 40, U 42, and V 44, ((A) of FIG. 2) respectively, of a selected color, for example, blue of background 16, to be keyed out or made transparent from a color video input image, for example, color video input image 10 shown in FIG. 1. In this third particular embodiment, the pre-determined values of each set, set 70, set 72, and set 74, would also be integer values of 1 and 0, but, here, in addition to or instead of the luminance (Y) individual color component LUT, Y-LUT 60, featuring a set of pre-determined values accounting for high tolerance to changes in lighting, affecting the luminance (Y) component or the overall level of the color, of input image pixels of the color video input image, there would be at least one of the chromatic (U, V) individual color component LUTs, U-LUT 62 and V-LUT 64, featuring a set of pre-determined values accounting for high tolerance of the respective at least one of the chromatic (U, V) components of the color, of input image pixels of the color video input image.

Accordingly, in FIG. 3, in addition to or instead of the luminance (Y) individual color component LUT, Y-LUT 60, there would be at least one of the chromatic (U, V) individual color component LUTs, U-LUT 62 and V-LUT 64, having a plurality of at least five or seven pre-determined values of 1, centered around and associated with the value of the respective at least one of the chromatic (U, V) individual color components of the selected color to be keyed out or made transparent from the color video input image. More specifically, the at least five or seven pre-determined values of 1 in each of at least one of the chromatic (U, V) individual color component LUTs, U-LUT and V-LUT, would correspond to (i) the actual value, (ii) at least two or three immediately preceding values, and, (iii) at least two or three immediately succeeding values, of the respective at least one of the chromatic (U, V) individual color components of the selected color, for example, blue of background 16, to be keyed out or to be made transparent from a color video input image, for example, color video input image 10 shown in FIG. 1.

Accordingly, Step (d) in the third particular embodiment of the general method of the present invention is implemented whereby in the set of predetermined values of at least one of the chromatic (U, V) individual color component LUTs, U-LUT and V-LUT, there is a plurality of pre-determined values, preferably at least five or seven pre-determined values centered around and associated with the value of the respective at least one of the chromatic (U, V) individual color components of the selected color to be keyed out or made transparent from the color video input image. Other steps and aspects of implementing the third particular embodiment of the method are the same and in accordance with the above described general method. The objective of using this third particular embodiment of the general method is for enabling the keying out or making transparent input image pixels having a level of brightness of color within a high tolerance range of the selected color to be keyed out or to be made transparent from the color video input image, rather than being restricted or limited to keying out or making transparent input image pixels having a level of brightness of color either nearly identical or similar, in addition to identical, to the level of brightness of the selected color to be keyed out or to be made transparent from the color video input image.

In the fourth particular embodiment of the method, each of the individual color component LUTs features a set of pre-determined values accounting for mixing colors such as for generating smooth edges, from input image pixels of the color video input image, used for calculating pixel transparency values of input image pixels of the color video input image. This fourth particular embodiment is understood by referring again to FIG. 4, which illustrates Step (d), the step of assigning a set, for example, set 90, set 92, and set 94, of pre-determined values to each individual color component LUT, Y-LUT 60, U-LUT 62, and V-LUT 64, respectively, whose values are associated with the values of each individual color component, Y 40, U 42, and V 44, (of FIG. 2 (A)) respectively, of a selected color, for example, blue of background 16, to be keyed out or made transparent from a color video input image, for example, color video input image 10 shown in FIG. 1. In this fourth particular embodiment, the pre-determined values of each set, set 90, set 92, and set 94, are integer values of 1 and 0, and, here, in addition to the set of the pre-determined values in Y-LUT 60 accounting for high tolerance to changes in lighting, affecting the luminance (Y) component or the overall level of the color, of input image pixels of the color video input image, the set of the pre-determined values in each individual color component LUT, Y-LUT 60, U-LUT 62, and V-LUT 64, accounts for mixing colors such as for generating smooth edges from input image pixels of the color video input image, further described as follows.

In the first three particular embodiments of the method illustrated by FIGS. 2-3, in each of the individual color component LUTs, Y-LUT 60, U-LUT 62, and V-LUT 64, the pre-determined values of each set are integer values of 1 and 0 only, which, according to previously described Step (e), are used for calculating a transparency value of each input image pixel for either completely keying out or not keying out at all, respectively, the input image pixel from the color video input image. This procedure may cause the generation of jagged or rough edges of the part or region of the color video input image corresponding to the selected color, for example, blue of background 16, to be keyed out or to be made transparent from the color video input image, for example, color video input image 10 shown in FIG. 1. Using intermediate, or equivalently, non-integer, pre-determined values between 0 and 1, in addition to using pre-determined values of 1 and 0, in the sets of pre-determined values in the individual color component LUTs, enables partially keying out or partially making transparent a number of input image pixels from the color video input image. This procedure is used for blending or mixing, instead of replacing, colors of a number of the input image pixels with colors of the corresponding pixels in a desired background of an insert image such as insert image 18 of animated weather map 14 in FIG. 1, for forming composite color video image 20 of weatherman 12 in front of animated weather map 14. Specifically, by using this procedure, in accordance to above described Step (g), there is generating smooth edges in composite color video image 20 from the input image pixels associated with the edges of weatherman 12.

In FIG. 4, it is particularly noted that in each of the individual color component LUTs, Y-LUT 60, U-LUT 62, and V-LUT 64, the pre-determined values of each set, set 90, set 92, and set 94, respectively, are integer values of 1 and 0, and, positive non-integer values of 0.8, 0.7, 0.5, 0.3, and 0.2, where, here, in addition to the set of the pre-determined values in Y-LUT 60 accounting for high tolerance to changes in lighting, affecting the luminance (Y) component or the overall level of the color, of input image pixels of the color video input image, the set of the pre-determined values in each individual color component LUT, Y-LUT 60, U-LUT 62, and V-LUT 64, accounts for mixing colors such as for generating smooth edges from input image pixels of the color video input image.

Accordingly, Step (d) in the fourth particular embodiment of the general method of the present invention is implemented whereby pre-determined values assigned to and stored in the individual color component LUTs, Y-LUT, U-LUT, and V-LUT, are selected from the group consisting of positive integer values, positive non-integer values, and zero, associated with the values of the respective individual color components, Y, U, and V, of the selected color to be keyed out or made transparent from the color video input image. In particular, pre-determined values assigned to and stored in the individual color component LUTs, Y-LUT, U-LUT, and V-LUT, are selected from the group consisting of integer values of 1 and 0, and, non-integer values between 0 and 1, associated with the values of the respective individual color components, Y, U, and V, of the selected color to be keyed out or made transparent from the color video input image. Other steps and aspects of implementing the fourth particular embodiment of the method are the same and in accordance with the above described general method. The objective of using this fourth particular embodiment of the general method is for using the sets of the pre-determined values in the individual color component LUTs for mixing colors of the color video input image with colors of another color video image and for generating smooth edges from the input image pixels of the color video input image.

While the invention has been described in conjunction with general and specific embodiments and examples thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for rapid color keying of a color video input image using individual color component Look-Up-Tables (LUTs), comprising the steps of:
(a) receiving the color video input image, featuring input image pixels, by an image processing device;
(b) characterizing the color video input image;
(c) selecting a color to be keyed out from the color video input image and assigning a value to each individual color component of said selected color;
(d) defining an individual color component LUT for each said individual color component of said selected color to be keyed out from the color video input image, and assigning a set of pre-determined values to each said defined individual color component LUT;
(e) calculating a transparency value for each said input image pixel of the color video input image from said individual color component LUTs of said selected color to be keyed out from the color video input image, for forming a plurality of said calculated transparency values of said input image pixels of the color video input image, whereby each said input image pixel is to be keyed out or made transparent to a variable extent or degree from the color video input image according to said calculated transparency value of said input image pixel;
(f) setting pixel transparency for each said input image pixel of the color video input image, from said transparency value calculated for said input image pixel of the color video input image, for forming a plurality of said set pixel transparencies of said input image pixels of the color video input image; and
(g) using said plurality of said set pixel transparencies of the color video input image for performing at least one procedure on the color video input image selected from the group consisting of an additional video image processing procedure on the color video input image and generating a color video output image corresponding to a keyed out form of the color video input image, each said at least one procedure includes said keying out or making transparent said input image pixels associated with said selected color to be keyed out from the color video input image.

2. The method of claim 1, whereby said characterizing the color video input image is performed using a color model whereby each said input image pixel features a color having a luminance individual color component and chromatic individual color components.

3. The method of claim 2, whereby each said individual color component has a value in a dynamic range of 0 to 255.

4. The method of claim 1, whereby said characterizing the color video input image is performed using a color model selected from the group consisting of RGB, YUV, and YCrCb.

5. The method of claim 1, whereby colors of said input image pixels are selected from the group consisting of linear combinations of primary colors, linear combinations of non-primary colors, and, linear combinations of primary colors and non-primary colors.

6. The method of claim 1, whereby there is at least one color associated with a number of said input image pixels to be keyed out or made transparent from the color video input image.

7. The method of claim 1, whereby said image processing device is a type of hardware acceleration device.

8. The method of claim 1, wherein step (c) said selected color is defined by three said individual color components.

9. The method of claim 1, wherein step (c) said selected color is defined by a luminance said individual color component and two chromatic said individual color components.

10. The method of claim 1, wherein step (c) said selected color is defined by a Y luminance said individual color component, and, U and V chromatic said individual color components.

11. The method of claim 1, wherein step (c) each said individual color component of said selected color has a value in a dynamic range of 0 to 255.

12. The method of claim 1, wherein step (d) there is defining a Y or luminance said individual color component LUT, a U or first chromatic said individual color component LUT, and a V or second chromatic said individual color component LUT, corresponding to a Y or luminance said individual color component, a U or first chromatic said individual color component, and a V or second chromatic said individual color component, respectively, of said selected color, each said individual color component LUT is defined as a table of said set of said pre-determined values which are assigned to, stored in, and retrieved from, each respective said individual color component LUT, by using a unique one-dimensional position index of a one-dimensional array.

13. The method of claim 1, whereby said pre-determined values of said defined individual color component LUTs are associated with values in a dynamic range of 0 to 255 of said individual color components of said selected color.

14. The method of claim 1, whereby said pre-determined values are selected from the group consisting of positive integer values, positive non-integer values, and zero.

15. The method of claim 1, wherein step (e) includes for each said input image pixel of the color video input image:
(i) retrieving a said pre-determined value from each said individual color component LUT, each said pre-determined value is associated with a value of a respective individual color component of said input image pixel; and
(ii) multiplying said pre-determined values retrieved from said individual color component LUTs for forming said transparency value for said input image pixel.

16. The method of claim 1, whereby said calculated transparency value of each said input image pixel is selected from group consisting of integers 1 and 0, and, non-integers between 0 and 1, whereby each said input image pixel of the color video input image having said calculated transparency value of said integer 1 is to be completely keyed out or to be made completely transparent from the color video input image, each said input image pixel of the color video input image having said calculated transparency value of said integer 0 is not to be keyed out or not to be made transparent from the color video input image, and each said input image pixel of the color video input image having said calculated transparency value of said non-integer between 0 and 1 is to be partially keyed out or partially made transparent from the color video input image.

17. The method of claim 1, wherein step (f) each said calculated transparency value of each said input image pixel is stored in a fourth individual component of said input image pixel, said fourth individual component is equivalent to an alpha component of said input image pixel, whereby set of all said calculated transparency values of all said input image pixels of the color video input image is stored in an alpha channel of the color video input image.

18. The method of claim 17, whereby said alpha channel is stored in terms selected from the group consisting of integer values only, non-integer values only, and, a combination of integer values and non-integer values.

19. The method of claim 17, whereby each said calculated transparency value which is non-integer between 0 and 1 is multiplied by 255 and converted to an integer value prior to said storing in said alpha channel of the color video input image.

20. The method of claim 17, wherein step (d) said predetermined values are positive integer and zero values only and there is including a maximal said positive integer value in each said set of said pre-determined values of each said individual color component LUT, whereby when said predetermined values are retrieved and multiplied for said forming said transparency value for each said input image pixel of the color video input image, maximal said calculated transparency value is 255 for each said input image pixel, whereby said alpha channel of said transparency values is obtained and stored in terms of said positive integer values in a dynamic range of 0 to 255.

21. The method of claim 1, whereby for each additional said color selected for said keying out or making transparent from the color video input image, step (f) further includes repeating step (c) through step (f).

22. The method of claim 1, wherein step (g) said additional video image processing procedure performed on the color video input image is combining or compositing the color video input image associated with said plurality of set pixel transparencies of the color video input image with another video image for forming a composite color video image.

23. The method of claim 1, whereby hardware acceleration is used for performing steps (a) through (b), whereby there is transferring, in turn or sequentially, a value of each individual color component of all said input image pixels of the color video input image in a form of a single component image to a hardware acceleration device.

24. The method of claim 23, whereby steps (c) through (d) are performed by associating each said single component image, one said single component image for each said individual color component, with a respective said individual color component LUT whose said pre-determined values are calculated by using software programs and are associated with said values of each respective said individual color component of said selected color to be keyed out or made transparent from the color video input image.

25. The method of claim 24, whereby said hardware acceleration device is used for performing step (e) for said calculating said transparency value for each said input image pixel of the color video input image by multiplying said pre-determined values retrieved from said respective individual color component LUTs associated with said respective single component image.

26. The method of claim 1, wherein step (d) in each said set of said pre-determined values of each said individual color component LUT there is a plurality of at least three said pre-determined values centered around and associated with each said value of each respective said individual color component of said selected color to be keyed out or made transparent from the color video input image, whereby there is said keying out or making transparent said input image pixels having a color within a range of said selected color to be keyed out or to be made transparent from the color video input image.

27. The method of claim 1, wherein step (d) in said set of said pre-determined values of a luminance said individual color component LUT there is a plurality of at least five said pre-determined values centered around and associated with a said value of a respective luminance said individual color component of said selected color to be keyed out or made transparent from the color video input image, whereby there is said keying out or making transparent said input image pixels having a luminance individual color component affected by varying lighting conditions within a high tolerance range of said luminance said individual color component of said selected color to be keyed out or to be made transparent from the color video input image.

28. The method of claim 1, wherein step (d) in said set of said pre-determined values of at least one chromatic said individual color component LUT there is a plurality of at least five said pre-determined values centered around and associated with a said value of a respective at least one chromatic said individual color component of said selected color to be keyed out or made transparent from the color video input image, whereby there is said keying out or making transparent said input image pixels having at least one chromatic individual color component within a high tolerance range of respective said at least one chromatic said individual color component of said selected color to be keyed out or to be made transparent from the color video input image.

29. The method of claim 1, wherein step (d) said pre-determined values assigned to and stored in each said individual color component LUT are selected from the group consisting of positive integer values, positive non-integer values, and zero, associated with said values of said respective individual color components of said selected color to be keyed out or made transparent from the color video input image, whereby each said set of said pre-determined values in each said individual color component LUT is used for mixing colors of the color video input image with colors of another color video image and for generating smooth edges from said input image pixels of the color video input image.
